(19) United States
(12) Patent Application Publication
(10) Pub. No.: US 2014/0178669 A1
(43) Pub. Date: Jun. 26, 2014

(54) ADHESIVE TAPE

(71) Applicant: Hon Hai Precision Industry Co., Ltd., New Taipei (TW)

(72) Inventor: MING-JEN CHANG, New Taipei (TW)

(73) Assignee: HON HAI PRECISION INDUSTRY CO., LTD., New Taipei (TW)

(21) Appl. No.: 14/108,558

(22) Filed: Dec. 17, 2013

(30) Foreign Application Priority Data
Dec. 24, 2012 (TW) 101149437

(51) Int. Cl. C09J 7/02

(52) U.S. Cl. CPC C09J 7/02
USPC 428/323; 428/354

(57) ABSTRACT

An adhesive tape is non-permanent before pressing and heating includes a protective layer, an adhesive layer formed on the protective layer, and a plurality of adhesive particles dispersed on the adhesive layer. The adhesive force of the adhesive particles is less than that of the adhesive layer. The adhesive tape is easily peeled off from a workpiece to allow reworking before final bonding is required.

### BACKGROUND

1. Technical Field

The present disclosure relates to adhesive tapes and particularly to an adhesive tape which can be easily peeled off.

2. Description of the Related Art

In an assembling process of consumer electronics, an adhesive tape is employed to bond two workpieces together. The adhesive tape should have a good adhesive force to bond the workpieces together strongly. At the same time, the adhesive tape should be easily peeled off from the two workpieces when a reworking or another process is required.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views.

FIG. 1 shows one embodiment of an adhesive tape adhered to a workpiece in a first state.

FIG. 2 is similar to FIG. 1, but showing the adhesive tape adhered to the workpiece in a second state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

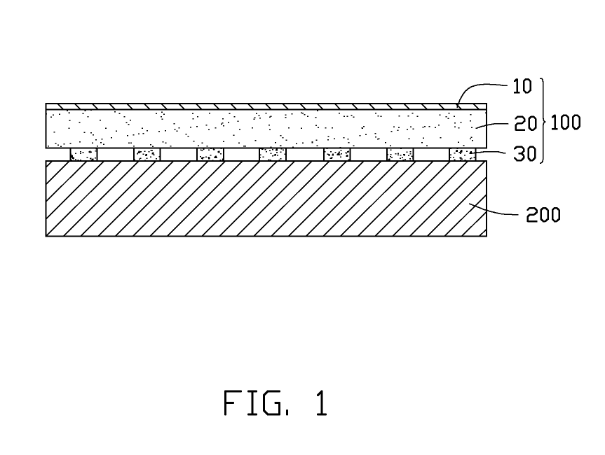

FIG. 1 shows a first embodiment of an adhesive tape 100. The adhesive tape 100 includes a protective layer 10, an adhesive layer 20 formed on the protective layer 10, and a plurality of adhesive particles 30 dispersed on the adhesive layer 20. The protective layer 10 is made of releasing or non-stick paper or material, such as plastic film or kraft. An adhesive force of the adhesive layer 20 is greater than an adhesive force of the adhesive particles 30. In an illustrated embodiment, the adhesive force of the adhesive layer 20 is equal to or higher than about 1.5 kilogram per inch (kg/in). The adhesive force of the adhesive particles 30 at saturation density is in a range from about 0.1 kg/in to about 1.0 kg/in. The dispersed density of the adhesive particles 30 can be adjusted as needed. In the illustrated embodiment, the adhesive particles 30 are uniformly dispersed on the adhesive layer 20 by a spraying method. The size of each adhesive particle 30 is in a range from about 0.1 micrometers (μm) to about 100 μm. The dispersed density of the adhesive particles 30 is in a range from about 10% to about 80%.

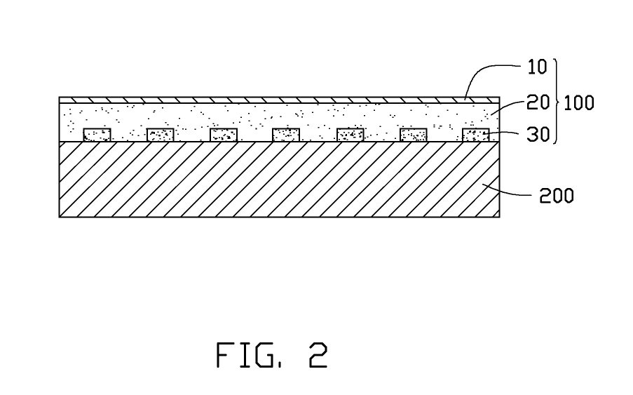

In use, the adhesive particles 30 make first contact with a workpiece 200, and the bonding strength between the adhesive tape 100 and the workpiece 200 is relatively low, such that the adhesive tape 100 is easily peeled off from the workpiece 200 (referring to FIG. 1). The adhesive tape 100 is then pressed or/and heated, and the adhesive layer 20 penetrates through the adhesive particles 30 to the workpiece 200 via gaps between the adhesive particles 30 and after a predetermined time span will adhere to the workpiece 200 with full bonding strength (refer to FIG. 2). The predetermined time span is defined as a reworking time span, during which time span the adhesive tape 100 is easily peeled off, and the workpiece 200 is again available for reworking

The reworking time span can be adjusted by adjusting a pressure exerted on the adhesive tape 100, by a heating temperature, by the size of each adhesive particle 30, and the dispersed density of the adhesive particles 30. An original viscosity of the adhesive tape 100 and a final viscosity of the adhesive tape 100 can be adjusted by the dispersed density of the adhesive particles 30.

To illustrate how the heating temperature, the size of each adhesive particle 30, and the dispersed density of the adhesive particles 30 can adjust the reworking time span, four examples are listed in table 1 below. No pressure is exerted on the adhesive tape 100 in the four examples.

TABLE 1
Properties of the Adhesive Tape

| | | | Heating | Rework | Original | Final |
|---|---|---|---|---|---|---|
| | | Dis- | temperature | time | vis- | vis- |
| | size | persing | (degree | span | cosity | cosity |
| Example | (μm) | density | Celsius) | (hour) | (Kg/in) | (Kg/in) |
| Example 1 | 8 | 50 | 25 | 24 | 0.6 | 1.6 |
| Example 2 | 15 | 30 | 40 | 18 | 0.8 | 2.0 |
| Example 3 | 15 | 40 | 40 | 22 | 0.5 | 1.9 |
| Example 4 | 6 | 20 | 25 | 10 | 1.2 | 2.5 |

When the adhesive tape 100 is adhered to the workpiece 200 at an initial state (a first state), only the adhesive particles 30 having a low adhesive force adhere to the workpiece 100, so that the adhesive tape 100 is easily peeled off from the workpiece. When the adhesive layer 20 permeates the adhesive particles 30 via the gaps between the adhesive particles 30 and adheres to the workpiece 100, the bonding strength between the adhesive tape 100 and the workpiece 200 is improved and increases over time. In addition, the reworking time span can be easily adjusted by adjusting the pressure exerted on the adhesive tape 100, a heating temperature, the size of each adhesive particle 30, and the dispersed density of the adhesive particles 30.

It is to be understood, however, that even though numerous characteristics and advantages of the disclosure have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. An adhesive tape, comprising:
a protective layer;
an adhesive layer formed on the protective layer; and
a plurality of adhesive particles dispersed on the adhesive layer, wherein an adhesive force of the adhesive layer is greater than an adhesive force of the plurality of adhesive particles.

2. The adhesive tape of claim 1, wherein the adhesive force of the adhesive layer is equal to or greater than about 1.5 kg/in, and the adhesive force of the plurality of adhesive particles is in a range from about 0.1 kg/in to about 1.0 kg/in.

3. The adhesive tape of claim 1, wherein the plurality of adhesive particles are uniformly dispersed on the adhesive layer.

4. The adhesive tape of claim 1, wherein the dispersed density of the plurality of adhesive particles is in a range from about 10% to about 80%.

5. The adhesive tape of claim 4, wherein the dispersed density of the plurality of adhesive particles is in a range from about 20% to about 50%.

6. The adhesive tape of claim 1, wherein a size of each adhesive particle is in a range from about 0.1 μm to about 100 μm.

7. The adhesive tape of claim 6, wherein a size of each adhesive particle is in a range from about 6 μm to about 15 μm.
